(19) United States
(12) Patent Application Publication
(10) Pub. No.: US 2026/0126331 A1
(43) Pub. Date: May 7, 2026

(54) PRESSURE SENSORS AND ASSOCIATED METHODS

(71) Applicants: Stoneridge Asia Pacific Electronics (Suzhou) Co. Ltd., Suzhou (CN); Stoneridge Control Devices, Inc., Novi, MI (US)

(72) Inventors: Rick Yu, Suzhou (CN); Leslie Jiang, Suzhou (CN); Jack Yang, Suzhou (CN); Alex Gao, Suzhou (CN); Harish Chowdhary Athipatla, Canton, MI (US)

(21) Appl. No.: 19/377,315

(22) Filed: Nov. 3, 2025

Related U.S. Application Data
(60) Provisional application No. 63/716,680, filed on Nov. 5, 2024.

(51) Int. Cl. G01L 9/12; G01L 9/00; G01L 19/00; G01L 19/06; G01L 27/00

(52) U.S. Cl. CPC G01L 9/12; G01L 9/0075; G01L 19/0084; G01L 19/0654; G01L 27/002

(57) ABSTRACT

A pressure sensor assembly includes a housing defining a central through-bore with a first end having a threaded portion for coupling to a pressurized system and a second end defining a cavity. A ceramic capacitive sensor is disposed in the cavity and varies capacitance in response to deflection of a ceramic diaphragm under applied pressure communicated through the through-bore. A flexible printed circuit board assembly in the cavity is electrically connected to the ceramic capacitive sensor and supports a conditioner chip configured to convert capacitance variation into a calibrated analog voltage output. A connector coupled to the housing at the second end includes a plurality of terminals electrically coupled to the conditioner chip to provide the output to an external control unit.

### CROSS REFERENCE TO RELATED APPLICATIONS

This application claims priority to U.S. Provisional Ser. No. 63/716,680 filed on Nov. 5, 2024. The foregoing U.S. patent application is hereby incorporated herein in its entirety.

### BACKGROUND

Pressure sensors are used in a variety of applications to measure fluid pressure and provide corresponding output signals.

### SUMMARY

In some aspects, the techniques described herein relate to a pressure sensor assembly including: a housing defining a central through-bore having a first end including a threaded portion configured for coupling to a pressurized system, and a second end providing a cavity. A ceramic capacitive sensor is disposed in the cavity and configured to vary a capacitance in response to deflection of a ceramic diaphragm under applied pressure communicated through the through-bore. A flexible printed circuit board assembly is disposed in the cavity and electrically connected to the ceramic capacitive sensor. A conditioner chip is mounted on the flexible printed circuit board assembly and configured to convert the capacitance of the ceramic capacitive sensor into a calibrated analog voltage output. A connector is coupled to the housing at the second end and including a plurality of terminals electrically coupled to the conditioner chip.

In some aspects, the techniques described herein relate to a pressure sensor assembly, and the flexible printed circuit board assembly is bonded to a rigid FR-4 substrate to increase structural rigidity.

In some aspects, the techniques described herein relate to a pressure sensor assembly, and the conditioner chip is configured to perform offset and gain calibration of the analog voltage output.

In some aspects, the techniques described herein relate to a pressure sensor assembly, and the ceramic capacitive sensor is configured to operate in a medium pressure range between approximately 0.5 MPa and 2.0 MPa.

In some aspects, the techniques described herein relate to a pressure sensor assembly, and the housing further includes an O-ring positioned adjacent the threaded portion to provide fluid sealing when the assembly is installed in the pressurized system.

In some aspects, the techniques described herein relate to a pressure sensor assembly, further including a gasket disposed between the ceramic capacitive sensor and the housing.

In some aspects, the techniques described herein relate to a pressure sensor assembly, and the flexible printed circuit board assembly includes a first shelf and a second shelf, the conditioner chip being mounted to the first shelf, and connector terminals being electrically coupled to the second shelf.

In some aspects, the techniques described herein relate to a pressure sensor assembly, and the first shelf and the second shelf are formed from a continuous portion of the flexible printed circuit board.

In some aspects, the techniques described herein relate to a pressure sensor assembly, and the first shelf includes a first surface supporting the conditioner chip and an opposite surface bonded to a first FR4 board.

In some aspects, the techniques described herein relate to a pressure sensor assembly, and the second shelf is bonded to a second FR4 board disposed opposite the first FR4 board, such that the conditioner chip is disposed between the first shelf and the second shelf and mechanically reinforced by the first and second FR4 boards.

In some aspects, the techniques described herein relate to a pressure sensor assembly, and the first shelf is configured to mount one or more additional electronic components selected from the group consisting of: a capacitor, a transient voltage suppression (TVS) device, and a resistor.

In some aspects, the techniques described herein relate to a pressure sensor assembly, and the second shelf provides a landing area for the plurality of connector terminals to facilitate electrical coupling to the connector.

In some aspects, the techniques described herein relate to a pressure sensor assembly, and the flexible printed circuit board assembly includes one or more legs extending between the first FR4 board and the second FR4 board to provide both electrical interconnection and mechanical reinforcement.

In some aspects, the techniques described herein relate to a pressure sensor assembly, and three legs are provided circumferentially about the flexible printed circuit board assembly.

In some aspects, the techniques described herein relate to a pressure sensor assembly, and the legs define spacing for accommodating the conditioner chip between the first FR4 board and the second FR4 board.

In some aspects, the techniques described herein relate to a pressure sensor assembly, and the conditioner chip is configured to combine a capacitance-derived primary voltage with an internal calibration voltage to generate the calibrated analog voltage output.

In some aspects, the techniques described herein relate to a pressure sensor assembly, and the conditioner chip employs digital-to-analog calibration parameters including a DAC_OFF value and a DAC_GAIN value to calibrate offset and full-scale range.

In some aspects, the techniques described herein relate to a pressure sensor assembly, and the conditioner chip is disposed between the first shelf and the second shelf of the flexible printed circuit board assembly.

In some aspects, the techniques described herein relate to a pressure sensor assembly, and the conditioner chip is mounted to a first surface of the first shelf, and a corresponding FR4 board is bonded to an opposite surface of the first shelf.

In some aspects, the techniques described herein relate to a pressure sensor assembly, and a second FR4 board is positioned opposite the second shelf relative to the first shelf, such that the conditioner chip is sandwiched between reinforced shelves of the flexible printed circuit board assembly.

In some aspects, the techniques described herein relate to a pressure sensor assembly, and a gel layer is omitted between the gasket and the ceramic capacitive sensor.

### BRIEF DESCRIPTION OF THE DRAWINGS

FIG. 1 is an exploded perspective view of an example pressure sensor assembly.

FIG. 2 is a cross-sectional view of the housing of the example pressure sensor assembly.

FIGS. 3A and 3B are schematic diagrams of the ceramic capacitive sensor in an unpressurized state and a pressurized state, respectively.

FIG. 4 is a perspective view of an example flexible printed circuit board assembly (FPCBA) illustrating shelves, legs, and FR4 boards for supporting a conditioner chip and electrical connections.

FIG. 5 is an exploded perspective view of an example pressure sensor assembly.

### DETAILED DESCRIPTION

This application relates generally to pressure sensors, and more specifically to ceramic capacitive pressure sensor assemblies incorporating a sensor conditioner integrated circuit mounted on a flexible printed circuit board reinforced with a rigid substrate, which may be used in medium-pressure fluid monitoring applications in some implementations.

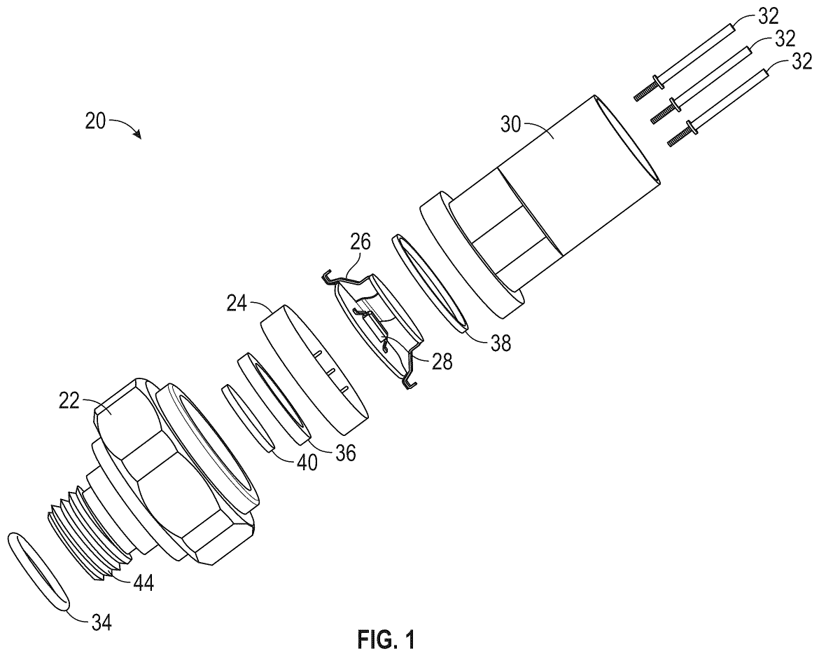

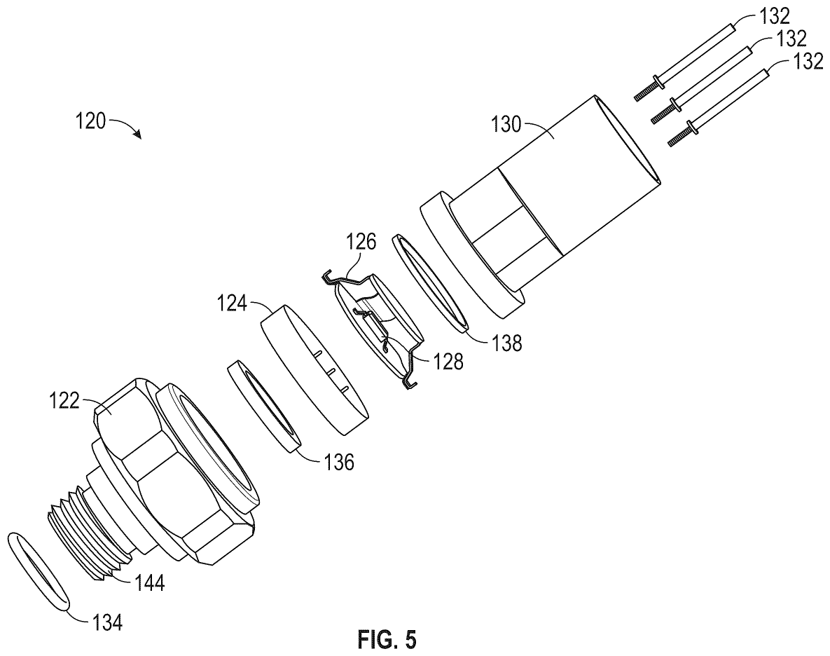

FIG. 1 is an exploded perspective view of an example pressure sensor assembly 20. The sensor assembly 20 includes a housing 22, a ceramic capacitive sensor 24, a flexible printed circuit board assembly (FPCBA) 26, a conditioner chip 28, and a connector 30 having a plurality of terminals 32. One or more sealing members, such as an o-ring 34, a gasket 36, and a quantity of sealant 38 (e.g., Room-Temperature Vulcanizing silicone adhesive or other similar adhesives), may be provided for environmental sealing of the assembly. In some implementations, a gel layer 40 is disposed over the ceramic capacitive sensor 24. In other implementations, as shown in the example pressure assembly 120 in FIG. 5, the gel layer 40 is omitted.

In some implementations, the pressure sensor assembly 20 may be configured for use in monitoring engine oil pressure, fuel rail pressure, and exhaust gas pressure. The sensor assembly 20 may be particularly well suited for use in diesel engines, although it will be understood that the assembly may also be employed in gasoline engines or in other fluid monitoring systems outside the automotive context.

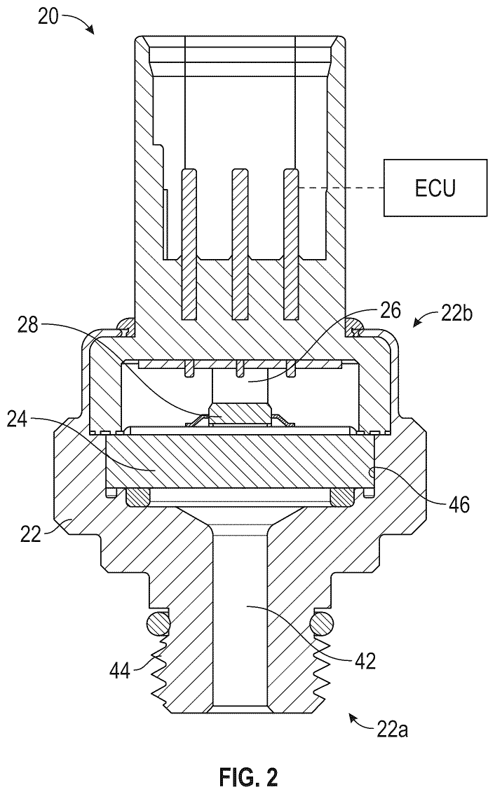

As illustrated in FIG. 2, the example housing 22 defines a central through-bore 42 that extends axially between a first end 22a and an opposite second end 22b. The first end 22a includes a threaded portion 44 configured for coupling the sensor assembly 20 to a pressurized system such as an engine block, fuel rail, or exhaust manifold. The second end 22b provides cavity 46 sized to receive the ceramic capacitive sensor 24, the FPCBA 26, and the conditioner chip 28. In this manner, the through-bore 42 directs fluid pressure to the diaphragm of the ceramic capacitive sensor 24, while the cavity 46 houses the associated electronic components. The connector 30 may be connected at the second end 22b.

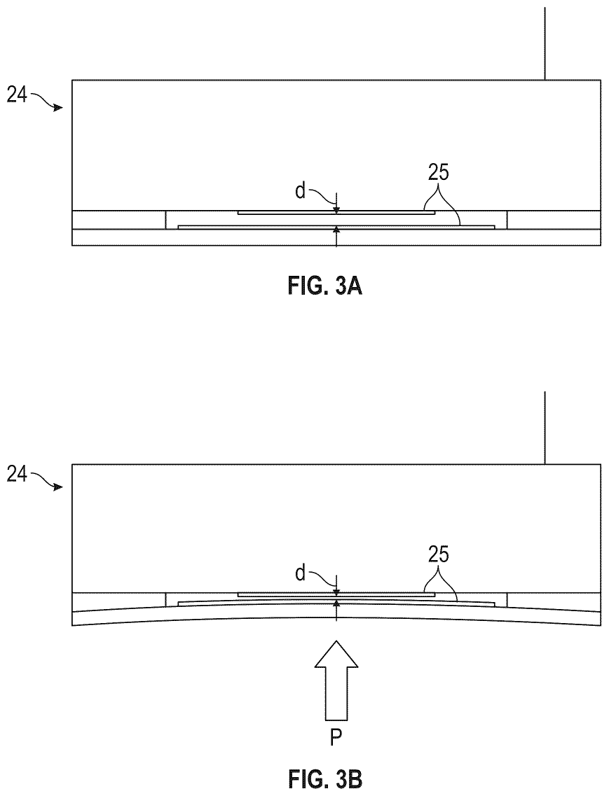

Referring to FIGS. 3A and 3B, the example ceramic capacitive sensor 24 includes a ceramic diaphragm that deflects in response to fluid pressure communicated through the through-bore of the housing 22. The diaphragm deflection produces a change in capacitance that is proportional to the applied pressure.

In operation, as shown schematically in FIG. 3A, when the ceramic capacitive sensor 24 is not exposed to pressure, the ceramic diaphragm remains substantially undeformed. Under these conditions, the spacing d between the electrodes 25 remains constant, and the output capacitance of the sensor 24 is a fixed value. The capacitance value in this state may be calculated, for example, according to the relationship: C=ε*S/(4πkd), where ε represents the dielectric constant, S represents the electrode surface area, k is a proportionality constant, and d is the electrode spacing.

When the ceramic capacitive sensor 24 is subjected to fluid pressure, as shown schematically in FIG. 3B, the ceramic diaphragm undergoes a small deformation, thereby reducing the electrode spacing d. As the spacing decreases, the capacitance increases proportionally. The resulting change in capacitance, ΔC, may be determined, for example, using the following expression: ΔC=C0*ε*Δd/(4πk(d−Δd)), where C₀ is the nominal capacitance, and Δd represents the change in spacing. This capacitance variation provides the basis for measurement, as it is subsequently processed by the conditioner chip 28 and converted into a corresponding calibrated output signal.

The cavity 46 of the housing 22 may be dimensioned larger than the through-bore 42. In one example, the cavity 46 may have a greater diameter than the through-bore 42, thereby providing a shoulder or step within the housing 22 against which the ceramic capacitive sensor 24 and/or gasket 36 may be seated. In implementations, the cavity 46 is arranged concentrically with the through-bore 42 along a common axis, providing direct communication of fluid pressure while permitting accommodation of the sensor and associated electronics. In implementations, the cavity 46 may be formed with a cylindrical geometry, a stepped bore geometry, or a counterbore geometry, providing sufficient space for one or more of the sensor 24, the FPCBA 26, the conditioner chip 28, and one or more sealing members. In this manner, the through-bore 42 serves to transmit pressure to the sensor diaphragm while the larger cavity 46 provides mounting volume for the sensor and electronic components.

In implementations, the ceramic capacitive sensor 24 is particularly suitable for use in medium pressure environments, such as pressures ranging from approximately 0.5 MPa to 2.0 MPa, whereas conventional resistive bridge sensors are more commonly employed in low-pressure applications. In addition, the ceramic capacitive sensor 24 provides improved accuracy compared to resistive bridge sensors. The FPCBA 26 may be laminated or otherwise bonded to an FR4 substrate to further increase structural strength and improve durability under vibration.

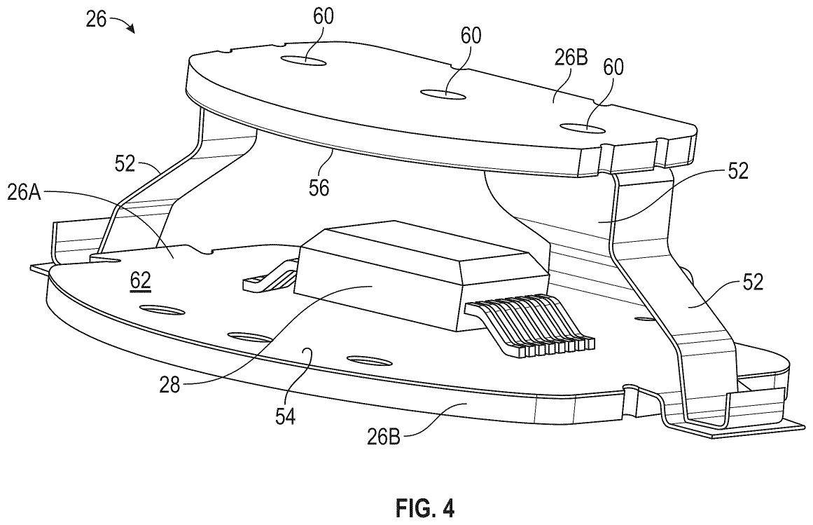

Referring to FIG. 4, with continued reference to FIG. 1, the FPCBA 26 supports electrical interconnections to the ceramic capacitive sensor 24 and provides mounting for the conditioner chip 28. The FPCBA 26 may include a flexible printed circuit board FPCB 26A that may be laminated or otherwise bonded to one or more rigid FR4 boards 26B for structural integrity.

FIG. 4 illustrates an example FPCBA 26 for use in the sensor assembly 20. The arrangement includes a flexible printed circuit board (FPCB) 26A and one or more rigid FR4 boards 26B. The FPCB 26A extends between and is laminated or otherwise bonded to the FR4 boards 26B, thereby forming a reinforced structure that combines the electrical routing flexibility of a flexible circuit with the mechanical strength of a rigid substrate.

One or more electronic components, such as the conditioner chip 28, may be mounted on the FPCB 26A within the region supported by the FR4 boards 26B. The FR4 boards 26B provide mechanical stability to the assembly, reduce bending stresses on solder joints, and/or improve vibration resistance during operation in harsh environments such as an engine compartment. In some implementations, the FPCB 26A may be positioned between two FR4 boards 26B, as shown, while in other implementations a single FR4 board 26B may be used. This rigid-flex arrangement allows compact packaging while maintaining robustness, such as for medium-pressure sensing applications.

In the illustrated example, the flexible printed circuit board 26A includes one or more upwardly extending legs 52 that connect a first shelf 54 to a second shelf 56 and a first FR4 board 26B to a second FR4 board 26B. These legs 52 of the FPCB 26A provide both electrical interconnection and mechanical support between the stacked FR4 boards 26B, as well as spacing for the conditioner chip 28 and/or other electrical components. By bending the FPCB 26A in this manner, the assembly achieves a rigid-flex configuration in which the flexible material provides routing between circuit layers while the FR4 boards 26B provide structural reinforcement. Although three legs 52 are shown in the illustrative example, more or fewer legs 52 may be utilized in other examples.

In the illustrated implementation, the flexible printed circuit board 26A further includes a first shelf 54 and a second shelf 56 spaced from the first shelf 54. The first shelf 54 provides a mounting surface for the conditioner chip 28 and one or more additional electrical components, such as a capacitor or a transient voltage suppression device, and is bonded to a corresponding FR4 board 26B for mechanical reinforcement. The second shelf 56 provides a landing area for the connector terminals 32 and facilitates electrical coupling to the external connector 30, and is likewise bonded to a corresponding FR4 board 26B. The first shelf 54 and second shelf 56 may be formed from a continuous portion of the FPCB 26A, which extends between and is bonded to an FR4 board 26B. This arrangement provides compact routing between the connector 30 and the ceramic capacitive sensor 24 (see FIG. 1) while also reinforcing the structural connection between the FR4 boards 26B and improving durability in vibration-intensive environments.

In some implementations, the conditioner chip 28 is disposed between the first shelf 54 and the second shelf 56 of the FPCB 26A. The conditioner chip 28 may be mounted to a first surface of the first shelf 54, while a corresponding FR4 board 26B is bonded to an opposite surface of the first shelf 54, as shown in the illustrative example. A second FR4 board 26B may be positioned opposite the second shelf 56 relative to the first shelf 54, such that the second shelf 56 is mechanically reinforced by the FR4 board 26B while also providing electrical connection to the connector terminals 32 (see FIGS. 1 and 2). The board 26B may include openings 60 for receiving the terminals 32. In implementations, this arrangement positions the conditioner chip 28 and associated circuitry between reinforced shelves of the FPCB 26A, thereby increasing mechanical stability and protecting the mounted components during exposure to vibration and thermal cycling.

The conditioner chip 28 may be an application-specific integrated circuit (ASIC) configured to convert the capacitance variation of the ceramic capacitive sensor 24 into a calibrated analog voltage output. The conditioner chip 28 may perform offset and gain calibration, temperature compensation, and filtering to ensure accuracy and stability of the sensor output. In some implementations, the ASIC may include analog, digital, or mixed-signal circuitry tailored to convert capacitance variations of the ceramic capacitive sensor 24 into a calibrated output. Such circuitry may include one or more of amplification, filtering, offset and span calibration, temperature compensation, analog-to-digital conversion, and reference voltage generation. In some examples, the ASIC may further include programmable memory for storage of calibration coefficients and/or diagnostic circuitry to monitor sensor performance. The conditioner chip 28 may be provided as a packaged discrete device mounted to the FPCB 26A, as a bare die wire-bonded directly to the FPCB, or as part of a system-on-chip that integrates additional logic functions. In alternative implementations, the conditioner chip 28 may be realized by another type of integrated circuit device, such as a microcontroller, application-specific standard product (ASSP), or a programmable logic device configured to perform equivalent conditioning and calibration functions.

In implementations, the capacitance variation produced by the ceramic capacitive sensor 24 is first converted by the conditioner chip 28 into a digital voltage, referred to herein as a primary voltage. The conditioner chip 28 may then combine the primary voltage with an internal calibration voltage to generate the final analog voltage output. In this manner, the assembly achieves a stable conversion from applied pressure to a calibrated analog output voltage suitable for external control systems.

In some implementations, the conditioner chip 28 may employ digital-to-analog calibration parameters, such as a DAC_OFF value and a DAC_GAIN value, to calibrate both the offset and the full-scale range of the analog voltage output. A digital input value, such as a DAC_DATA input represented by a 16-bit positive integer, may be supplied to the conditioner chip 28. Following this calibration, the error of the analog output is reduced, thereby permitting the analog output to be calculated directly from a calibrated value, such as PDATACAL. Because the internal reference voltage of the conditioner chip 28 exhibits low temperature drift, in some examples the offset and gain calibration may be performed a single time at room temperature. Temperature calibration coefficients of the ceramic capacitive sensor 24 may then be determined at the digital output of the conditioner chip 28, allowing temperature effects to be compensated without requiring additional analog calibration at varying operating conditions.

The connector 30 may be attached to the second end 22b of the housing 22 and includes a plurality of terminals 32. The terminals 32 provide external electrical connections, such as a power supply pin, an output pin, and a ground pin. The FPCBA 26 electrically couples the conditioner chip 28 to the terminals 32, thereby allowing the conditioned output signal to be provided to an external control system.

In some examples, additional electrical components 62 (shown schematically in FIG. 4), such as a capacitor and a transient voltage suppression (TVS) device, may be surface mounted on the FPCBA 26 in conjunction with the conditioner chip 28 to improve signal integrity and protect against electrical transients. One or more sealing members, including the gasket 36 and sealant 38 such as RTV adhesive, may be applied to ensure compliance with sealing requirements. In further examples, the gel layer 40 may be applied over the ceramic capacitive sensor 24 to prevent condensation from adversely affecting the sensor output.

FIG. 5 illustrates an example sensory assembly 120 substantially similar to the sensor assembly 20 except that the gel layer 40 is omitted. In this example, there is no structure axially between the gasket 136 and the housing 122. In some applications, the gel layer is not required to achieve adequate condensation resistance. In implementations, elimination of the gel layer can simplify assembly and reduce material costs without compromising condensation performance. In some implementations, sensor assemblies fabricated without the gel layer have demonstrated satisfactory performance in condensation testing, confirming that the waterproof characteristics of the ceramic sensor and the sealing arrangement between the gasket and housing provide adequate protection against condensation formation at the interface.

In implementations, the disclosed sensor assemblies 20 withstand extended service life, such as more than 500 million pressure cycles at frequencies of 2-5 Hz and temperatures between 15° C. and 35° C. The sensor assembly 20 may provide a response time of less than 5 milliseconds and maintain hysteresis error below 0.25 percent of full scale. In some implementations, output standard deviation may be maintained below 0.008 volts, confirming stable signal characteristics suitable for precision monitoring applications. The sensor assembly 20 may be operable over an extended temperature range, such as −40° C. to 140° C. in operation and up to 150° C. in storage.

Manufacturing of the example sensor assemblies 20 may include one or more of tin soldering of components to the FPCBA 26, manual or automated assembly, crimping of the connector 30, application of adhesive or gel, and high-temperature stress relief to stabilize the assembly. End-of-line testing may include calibration at multiple pressure and temperature points, helium leakage testing, and vibration testing of the housing 22. In implementations, vibration testing may include loading the assembly 20 at up to 30 G acceleration across a frequency range of 20 Hz to 2000 Hz.

In use, an example sensor assembly 20 may be operably coupled to an electronic control unit (ECU) 64 (shown schematically in FIG. 2) of a vehicle to provide continuous monitoring of engine oil pressure, fuel rail pressure, or exhaust gas back pressure. In other implementations, an example sensor assembly 20 may be integrated into other pressurized systems, such as hydraulic controls, refrigeration circuits, or aerospace fuel lines.

In some implementations, a method of monitoring pressure using one or more of the sensor assemblies 20 disclosed herein may include attaching the sensor assembly 20 to a pressurized system, such as an engine block, a fuel rail, an exhaust manifold, or another fluid conduit. The method further includes exposing the ceramic capacitive sensor 24 to fluid pressure communicated through the through-bore 42 of the housing 22, generating a capacitance variation in response to deflection of the ceramic diaphragm, conditioning the capacitance variation using the conditioner chip 28, and outputting a corresponding calibrated signal through the connector 30 to an external control unit, such as an ECU 64. In some examples, the method may further include calibrating the output signal by applying offset and span correction, temperature compensation, or filtering within the conditioner chip 28, and transmitting the calibrated pressure signal as an analog voltage, current loop signal, or digital output to the ECU 64.

It should be understood that the method of monitoring pressure using the sensor assembly 20 is not limited to the precise sequence described above. In some implementations, the method may include one or more of the disclosed steps, and the steps may be performed in an order different from that illustrated or described. Certain steps may be omitted, additional steps may be added, and equivalent substitutions may be made, all of which are considered to fall within the scope of the present disclosure.

In some implementations, a method of assembling one or more of the sensor assemblies 20 disclosed herein may include providing a housing 22 having a through-bore 42 and cavity 46, positioning a ceramic capacitive sensor 24 within the cavity 46, and attaching a flexible printed circuit board assembly (FPCBA) 26 in electrical communication with the ceramic capacitive sensor 24. The method may further include mounting a conditioner chip 28 to the FPCBA 26, attaching a connector 30 to the housing 22 at the second end 22b, and electrically coupling a plurality of terminals 32 of the connector 30 to the conditioner chip 28. In some examples, the method may also include bonding the FPCBA 26 to one or more FR4 boards 26B, attaching the ceramic capacitive sensor 24 against a gasket 36 or o-ring 34, applying a sealant 38 or gel layer 40 for environmental protection, and soldering or otherwise securing electrical components 62 to the FPCBA 26.

It should be understood that the method of assembling one or more of the sensor assemblies 20 disclosed herein is not limited to the precise sequence described above. In some implementations, the method may include one or more of the disclosed steps, and the steps may be performed in an order different from that illustrated or described. Certain steps may be omitted, additional steps may be added, and equivalent substitutions may be made, all of which are considered to fall within the scope of the present disclosure.

An example pressure sensor assembly according to one or more examples of this disclosure may be said to include a housing defining a central through-bore with a first end having a threaded portion for coupling to a pressurized system and a second end defining a cavity. A ceramic capacitive sensor is disposed in the cavity and varies capacitance in response to deflection of a ceramic diaphragm under applied pressure communicated through the through-bore. A flexible printed circuit board assembly in the cavity is electrically connected to the ceramic capacitive sensor and supports a conditioner chip configured to convert capacitance variation into a calibrated analog voltage output. A connector coupled to the housing at the second end includes a plurality of terminals electrically coupled to the conditioner chip to provide the output to an external control unit.

An example pressure sensor assembly according to one or more examples of this disclosure may be said to include a housing that defines an axial passage extending between a first end and a second end, the first end including a threaded interface for attachment to a pressurized component and the second end forming a cavity. Within the cavity is positioned a ceramic capacitive sensing element having a diaphragm configured to deflect under applied fluid pressure communicated through the passage, thereby producing a change in capacitance. Also arranged within the cavity is a flexible printed circuit board assembly electrically coupled to the sensing element and carrying a conditioner circuit that processes the capacitance change into a calibrated analog voltage signal. At the second end of the housing, a connector is secured, the connector including multiple terminals that are electrically linked to the conditioner circuit and adapted to deliver the conditioned output to an external electronic control unit or other device.

An example pressure sensor assembly according to one or more examples of this disclosure may be said to include a ceramic capacitive sensor operably coupled to a conditioner chip by way of a flexible printed circuit board assembly arranged within a housing. The housing defines a central through-bore extending between a first end and a second end, the first end including a threaded portion for mechanical coupling to a pressurized system and the second end forming a cavity to receive the sensor, the flexible printed circuit board assembly, and the conditioner chip. The ceramic capacitive sensor includes a diaphragm that deflects in response to fluid pressure communicated through the through-bore, thereby producing a capacitance change, which is processed by the conditioner chip into a calibrated analog output. A connector mounted at the second end of the housing provides a plurality of terminals electrically connected to the conditioner chip for supplying the conditioned output to an external electronic control unit or other system.

The description shall be interpreted as illustrative. A worker of ordinary skill in the art would understand that certain modifications could come within the scope of this disclosure. Various examples of the disclosure have been described. Any combination of the described systems, operations, or functions is contemplated. It is possible to use some of the components or features from any of the examples in combination with features or components from any of the other examples. The scope of the disclosure encompasses equivalents, variations, and combinations of the features described, even if not expressly illustrated in a single embodiment.

What is claimed is:

1. A pressure sensor assembly comprising:
a housing defining a central through-bore having a first end including a threaded portion configured for coupling to a pressurized system, and a second end providing a cavity;
a ceramic capacitive sensor disposed in the cavity and configured to vary a capacitance in response to deflection of a ceramic diaphragm under applied pressure communicated through the through-bore;
a flexible printed circuit board assembly disposed in the cavity and electrically connected to the ceramic capacitive sensor;
a conditioner chip mounted on the flexible printed circuit board assembly and configured to convert the capacitance of the ceramic capacitive sensor into a calibrated analog voltage output; and
a connector coupled to the housing at the second end and including a plurality of terminals electrically coupled to the conditioner chip.

2. The pressure sensor assembly of claim 1, wherein the flexible printed circuit board assembly is bonded to a rigid FR-4 substrate to increase structural rigidity.

3. The pressure sensor assembly of claim 1, wherein the conditioner chip is configured to perform offset and gain calibration of the analog voltage output.

4. The pressure sensor assembly of claim 1, wherein the ceramic capacitive sensor is configured to operate in a medium pressure range between approximately 0.5 MPa and 2.0 MPa.

5. The pressure sensor assembly of claim 1, wherein the housing further comprises an O-ring positioned adjacent the threaded portion to provide fluid sealing when the assembly is installed in the pressurized system.

6. The pressure sensor assembly of claim 1, further comprising a gasket disposed between the ceramic capacitive sensor and the housing.

7. The pressure sensor assembly of claim 1, wherein the flexible printed circuit board assembly includes a first shelf and a second shelf, the conditioner chip being mounted to the first shelf, and connector terminals being electrically coupled to the second shelf.

8. The pressure sensor assembly of claim 7, wherein the first shelf and the second shelf are formed from a continuous portion of the flexible printed circuit board.

9. The pressure sensor assembly of claim 7, wherein the first shelf includes a first surface supporting the conditioner chip and an opposite surface bonded to a first FR4 board.

10. The pressure sensor assembly of claim 9, wherein the second shelf is bonded to a second FR4 board disposed opposite the first FR4 board, such that the conditioner chip is disposed between the first shelf and the second shelf and mechanically reinforced by the first and second FR4 boards.

11. The pressure sensor assembly of claim 7, wherein the first shelf is configured to mount one or more additional electronic components selected from the group consisting of: a capacitor, a transient voltage suppression (TVS) device, and a resistor.

12. The pressure sensor assembly of claim 7, wherein the second shelf provides a landing area for the plurality of connector terminals to facilitate electrical coupling to the connector.

13. The pressure sensor assembly of claim 10, wherein the flexible printed circuit board assembly includes one or more legs extending between the first FR4 board and the second FR4 board to provide both electrical interconnection and mechanical reinforcement.

14. The pressure sensor assembly of claim 13, wherein three legs are provided circumferentially about the flexible printed circuit board assembly.

15. The pressure sensor assembly of claim 13, wherein the legs define spacing for accommodating the conditioner chip between the first FR4 board and the second FR4 board.

16. The pressure sensor assembly of claim 1, wherein the conditioner chip is configured to combine a capacitance-derived primary voltage with an internal calibration voltage to generate the calibrated analog voltage output.

17. The pressure sensor assembly of claim 1, wherein the conditioner chip employs digital-to-analog calibration parameters including a DAC_OFF value and a DAC_GAIN value to calibrate offset and full-scale range.

18. The pressure sensor assembly of claim 7, wherein the conditioner chip is disposed between the first shelf and the second shelf of the flexible printed circuit board assembly.

19. The pressure sensor assembly of claim 18, wherein the conditioner chip is mounted to a first surface of the first shelf, and a corresponding FR4 board is bonded to an opposite surface of the first shelf, and a second FR4 board is positioned opposite the second shelf relative to the first shelf, such that the conditioner chip is sandwiched between reinforced shelves of the flexible printed circuit board assembly.

20. The pressure sensor assembly of claim 6, wherein a gel layer is omitted between the gasket and the ceramic capacitive sensor.
